(19) United States
(12) Patent Application Publication
(10) Pub. No.: US 2015/0098020 A1
(43) Pub. Date: Apr. 9, 2015

(54) METHOD AND SYSTEM FOR BUFFER LEVEL BASED FRAME RATE RECOVERY

(71) Applicant: Nvidia Corporation, Santa Clara, CA (US)

(72) Inventor: Markus VILL, Munich (DE)

(73) Assignee: Nvidia Corporation, Santa Clara, CA (US)

(21) Appl. No.: 14/047,444

(22) Filed: Oct. 7, 2013

(51) Int. Cl. H04N 5/04; H04N 7/01

(52) U.S. Cl. CPC H04N 5/04; H04N 7/0127
USPC 348/513

(57) ABSTRACT

Embodiments of the present invention can measure internal buffer levels (e.g., queue levels) within the sink device and dynamically adjust step size values responsive to buffer level conditions that dynamically alter the sink frame rate. As such, embodiments of the present invention can find an equivalent of the source device frame rate on the sink device based on the sink device's own clock speed. In this manner, transmission bandwidth may be preserved as clocking information does not to need to be continuously communicated between the source device and the sink device.

### FIELD OF THE INVENTION

Embodiments of the present invention are generally related to the field of graphics processing and display technology.

### BACKGROUND OF THE INVENTION

When streaming an application from a source device, such as a host computer system, to a sink device, such as client device, a video stream is often transmitted at a fixed frame rate without any feedback. As such, the clocks of the source device and sink device may not be synchronized, thus, making it difficult to determine if the source and sink devices are operating at the same speed. This lack of synchronization may result in frame rate values being converted into different timings, which may result in conditions such as buffer overrun or underflow on the sink device after some time (depending on a positive or negative time shift).

Conventional methods of addressing this issue generally rely on the premise that a time reference/frame rate is valid only if both sides use the same reference clock. As such, conventional methods attempt to synchronize the clocks of the source device and the sink device by either a two-way communication or a single-way communication with a constant transmission time. This solution adds communication complexity and requires additional communication bandwidth to accommodate the clock transmission.

### SUMMARY OF THE INVENTION

Accordingly, a need exists to solve the problems discussed above. Embodiments of the present invention are operable to solve clock shift problems associated with frame rate synchronization between a source device and a sink device without explicit clock synchronization between the devices. Embodiments of the present invention can measure internal buffer levels (e.g., queue levels) within the sink device and dynamically adjust step size values responsive to buffer level conditions that dynamically alter the sink frame rate. As such, embodiments of the present invention can find an equivalent of the source device frame rate on the sink device based on the sink device's own clock speed. In this manner, transmission bandwidth may be preserved as clocking information does not to need to be continuously communicated between the source device and the sink device.

More specifically, in one embodiment, the present invention is implemented as a method of adjusting a frame rate on a sink device. The method includes receiving a plurality of frames from a source device over a communications network, in which the plurality of frames are communicated to the sink device at a fixed frame rate. Also, the method includes storing frames to be displayed in a queue of a frame buffer. The method also includes monitoring a current number of frames stored within the queue on the sink device, in which the sink device is operable to monitor the current number of frames in real-time.

Furthermore, the method includes adjusting a frame display rate on the sink device responsive to the current number of frames stored within the queue to approximate the fixed frame rate. In one embodiment, the monitoring further includes monitoring a convergence of the current number of frames to a pre-determined buffer queue level threshold for the frame buffer and adjusting the frame display rate responsive to the convergence. In one embodiment, the adjusting further includes adjusting a current frame display rate responsive to increases or decreases in the current number of frames, in which the current frame display rate is adjusted to a rate approximating the fixed frame rate.

In one embodiment, the adjusting further includes detecting an oscillation in the frame display rate by performing a summation on a set of previous frame rate changes detected over a period of time. In one embodiment, the detecting further includes averaging the set of previous frame rate changes to determine the oscillation. In one embodiment, the adjusting further includes adjusting a current step size value responsive to the oscillation, in which the current step size value is continuously adjusted to half of its current value until the frame display rate approximates the fixed frame rate. In one embodiment, the monitoring step and the adjusting step are performed at fixed time intervals.

In one embodiment, the present invention is implemented as a system for adjusting a frame rate on a sink device. The system includes a receiving module operable to receive a plurality of frames from a source device over a communications network, in which the plurality of frames are communicated to the sink device at a fixed frame rate, in which the receiving module is operable to store frames to be displayed in a queue of a frame buffer. The system also includes a monitoring module operable to monitor a current number of frames stored within the queue on the sink device, in which the monitoring module is operable to monitor the current number of frames in real-time.

Furthermore, the system includes a controller operable to adjust a frame display rate on the sink device responsive to the current number of frames stored within the queue and to approximate the fixed frame rate. In one embodiment, the monitoring module is further operable to monitor a convergence of the current number of frames to a pre-determined buffer queue level threshold for the frame buffer and the controller is further operable to adjust the frame display rate responsive to the convergence. In one embodiment, the controller is further operable to adjust a current frame display rate using a graphics system resident on the sink device responsive to increases or decreases in the current number of frames, in which the current frame display rate is adjusted to a rate approximates the fixed frame rate.

In one embodiment, the controller is further operable to detect an oscillation in the frame display rate by performing a summation on a set of previous frame rate changes detected over a period of time. In one embodiment, the controller is further operable to average the set of previous frame rate changes to determine the oscillation. In one embodiment, the controller is further operable to adjust a current step size value using a graphics system resident on the sink device responsive to the oscillation, in which the current step size value is continuously adjusted to half of its current value until the frame display rate approximates the fixed frame rate. In one embodiment, the monitoring module is operable to monitor the current number of frames and the controller is operable to adjust said frame display rate on said sink device at fixed time intervals.

In one embodiment, the present invention is implemented as a method of adjusting a frame rate on a sink device. The method includes receiving a plurality of frames from a source device over a communications network, in which the plurality of frames are communicated to the sink device at a target frame rate. Also, the method includes storing frames to be displayed in a buffer queue. The method includes monitoring a current number of frames stored within the buffer on the sink device, in which the sink device is operable to monitor the current number of frames in real-time. Additionally, the method includes, provided the current number of frames converges towards a pre-determined buffer queue threshold value, adjusting a frame display rate of the sink device. Furthermore, the method includes removing frames from the buffer queue for display at the frame rate of the sink device.

In one embodiment, the monitoring further includes monitoring a convergence of the current number of frames towards a pre-determined maximum buffer queue level threshold and towards a pre-determined minimum buffer queue level threshold for the frame buffer. In one embodiment, the adjusting further comprises adjusting a current frame display rate responsive to increases or decreases in the current number of frames, in which the current frame display rate is adjusted to a rate approximating the target frame rate.

In one embodiment, the adjusting further includes detecting an oscillation in the frame display rate by performing a summation on a set of previous frame rate changes detected over a period of time. In one embodiment, the detecting further includes averaging the set of previous frame rate changes to determine the oscillation. In one embodiment, the adjusting further includes adjusting a current step size value responsive to the oscillation, in which the current step size value is continuously adjusted to half of its current value until the frame display rate approximates the target frame rate. In one embodiment, the monitoring step and the adjusting step are performed at varying time intervals.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1A illustrates an exemplary method of adjusting a frame rate on a sink device responsive to sink device buffer levels in accordance with embodiments of the present invention.

FIG. 1B is a graphical representation of an exemplary frame buffer queue growth computations performed in accordance with embodiments of the present invention.

FIG. 1C is a graphical representation of an exemplary method of detecting oscillation within a frame rate in accordance with embodiments of the present invention.

FIG. 2A is an exemplary sink device capable of adjusting a frame rate responsive to sink device buffer levels in accordance with embodiments of the present invention.

FIG. 2B is another illustration of an exemplary method of adjusting a frame rate on a sink device responsive to sink device buffer levels in accordance with embodiments of the present invention.

FIG. 3A is a flowchart of an exemplary method of adjusting a frame rate on a sink device responsive to sink device buffer levels in an embodiment according to the present invention.

FIG. 3B is flowchart of an exemplary method of adjusting step size values on a sink device responsive to sink device buffer levels in an embodiment according to the present invention.

FIG. 3C is another flowchart of an exemplary method of adjusting step size values on a sink device responsive to sink device buffer levels in an embodiment according to the present invention.

FIG. 3D is flowchart of an exemplary method of detecting oscillation within frame rate values over a period of time in an embodiment according to the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

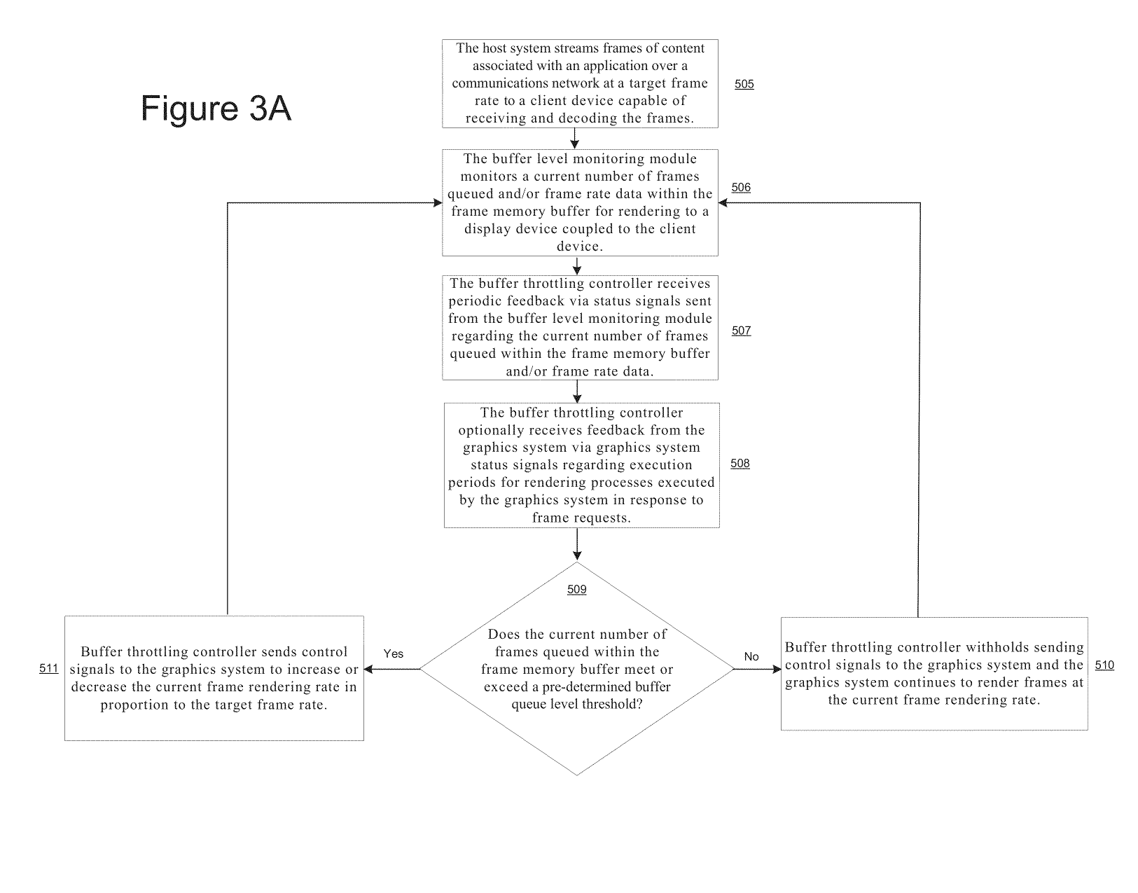

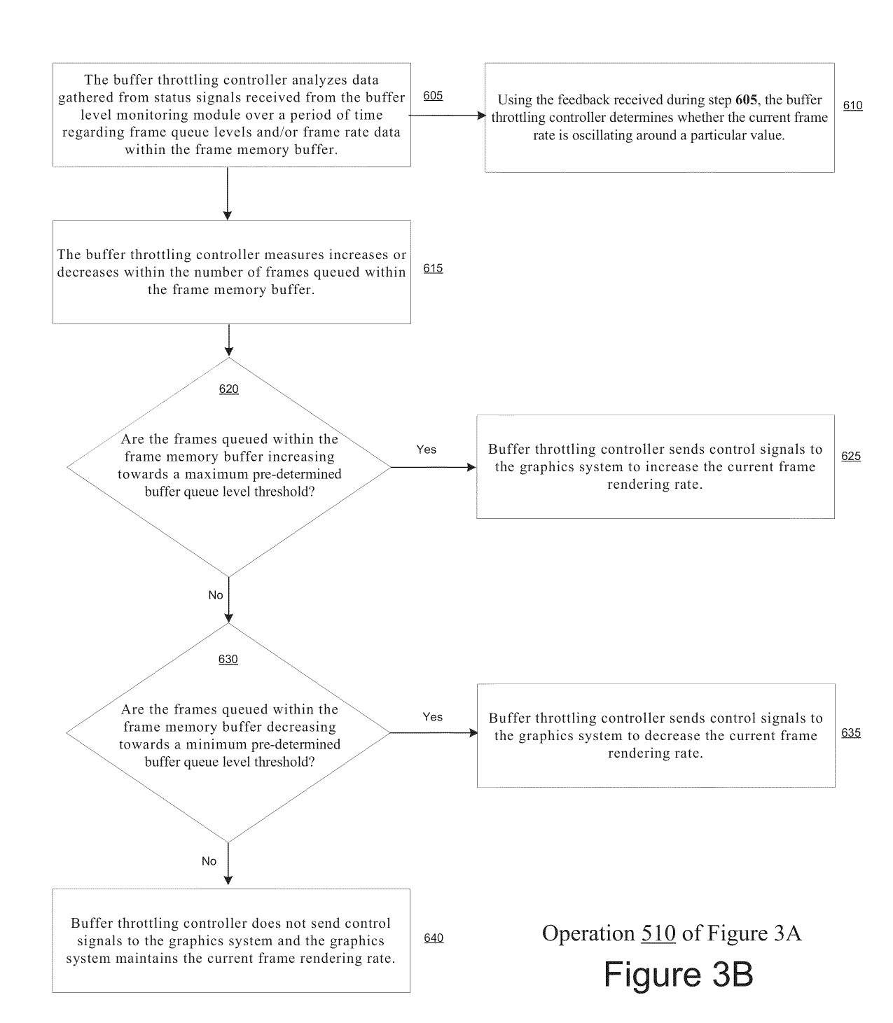

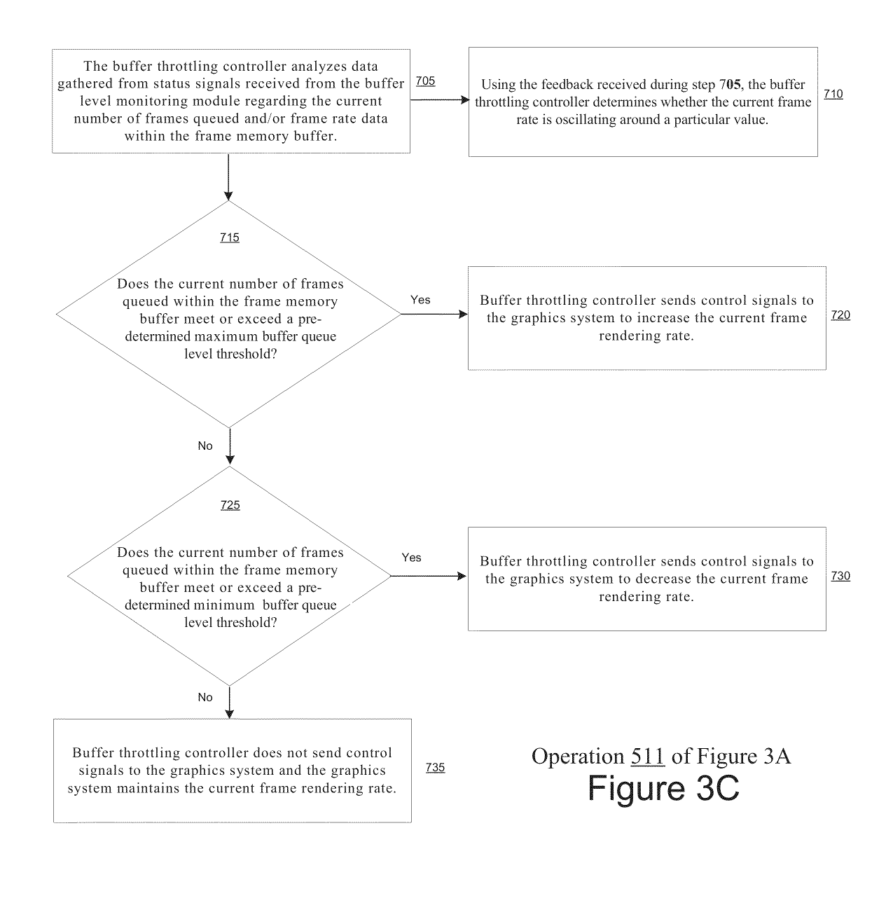

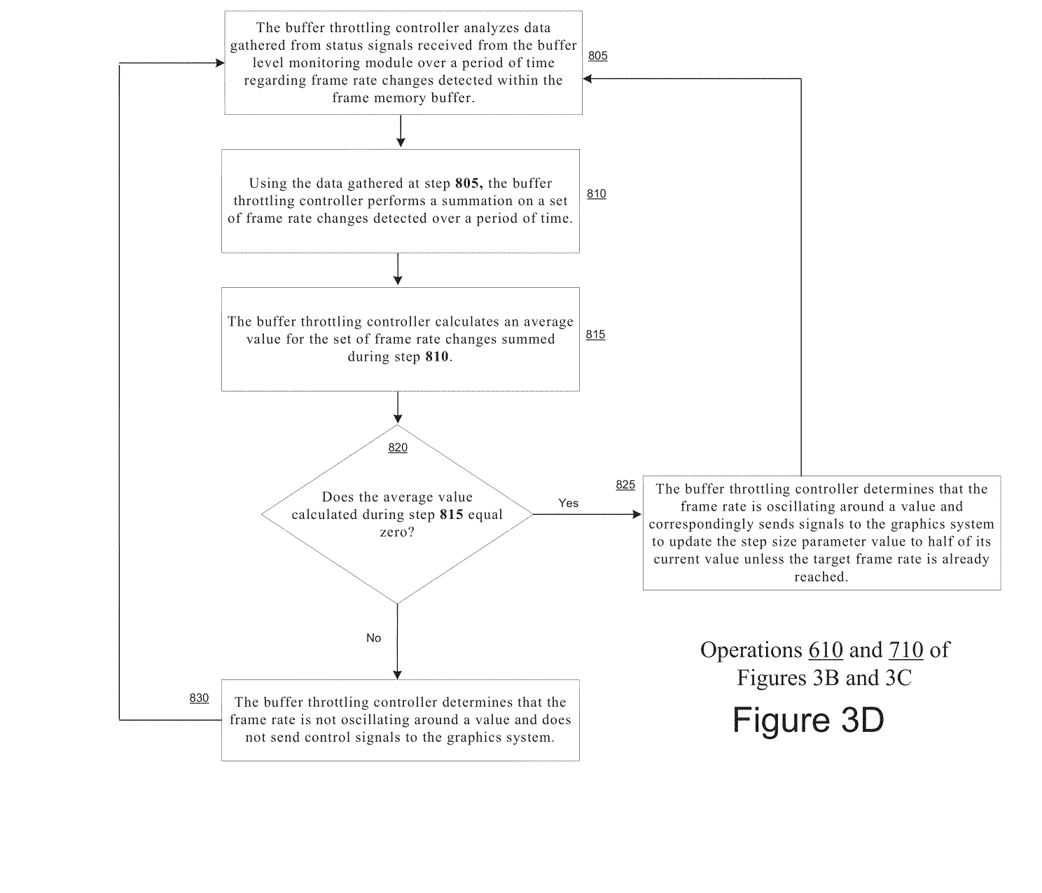

Portions of the detailed description that follow are presented and discussed in terms of a process. Although operations and sequencing thereof are disclosed in a figure herein (e.g., FIGS. 3A, 3B, 3C, 3D, etc.) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, system, and the like are intended to refer to a computer-related entity, specifically, either hardware, firmware, a combination of hardware and software, software, or software in execution. For example, a module can be, but is not limited to being, a process running on a processor, an integrated circuit, a subject, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon.

### Exemplary Method for Buffer Level Based Frame Rate Recovery

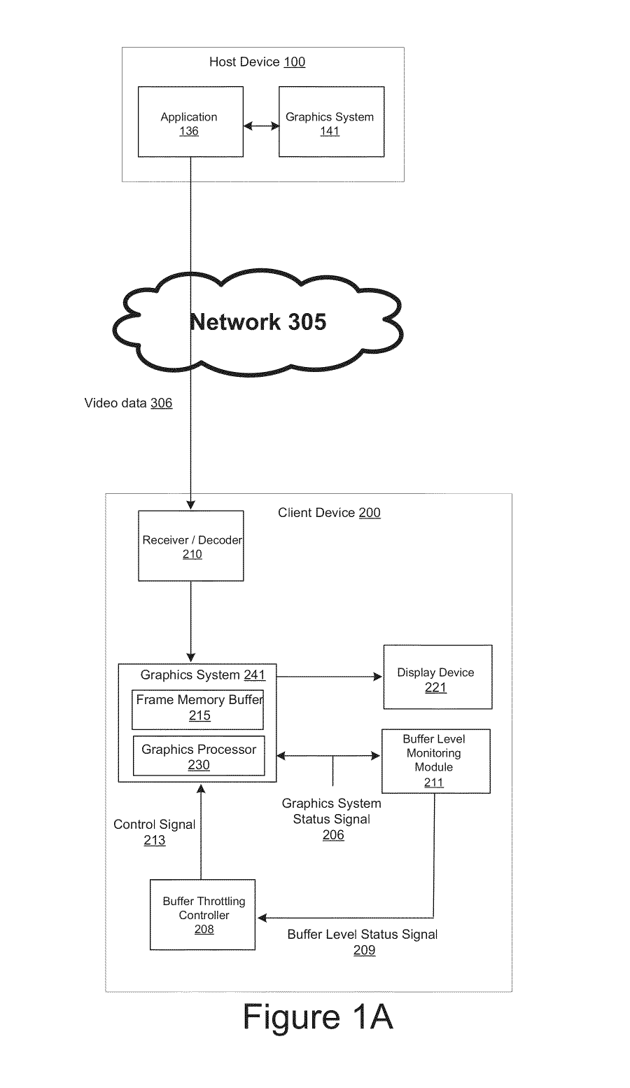

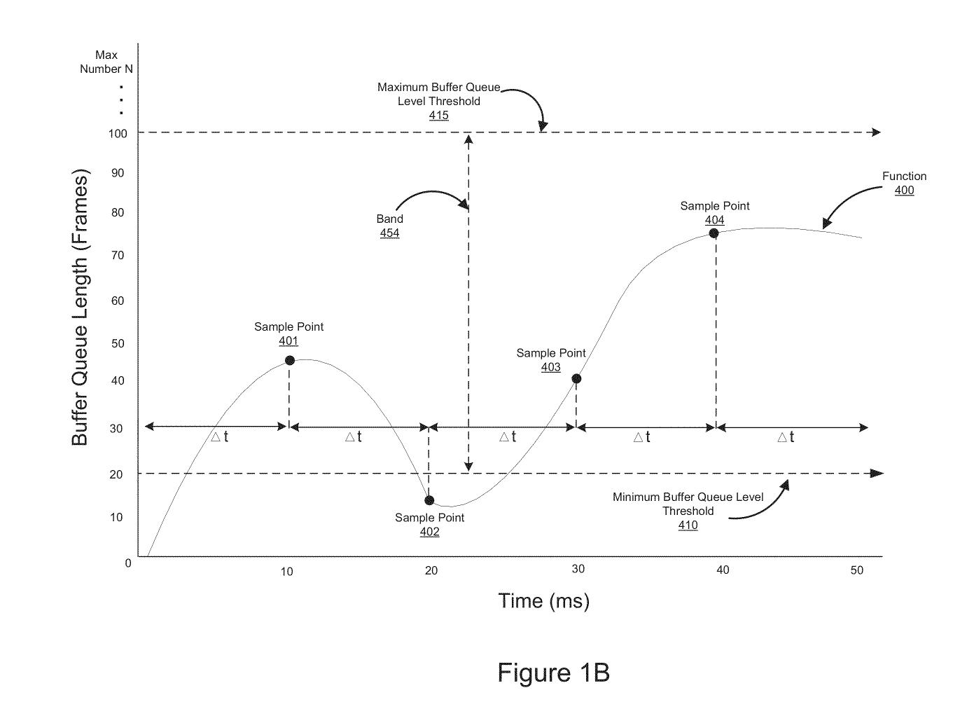

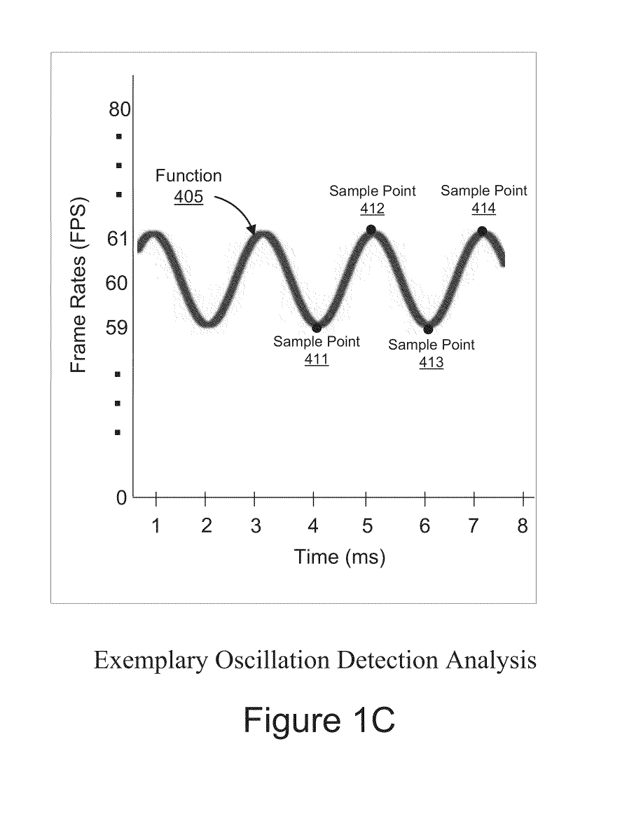

FIG. 1A provides an exemplary network communication between host device 100 and client device 200 in accordance with embodiments of the present invention. As such, FIG. 1A illustrates an exemplary method of adjusting a frame rate on a sink device (e.g., client device 200) with respect to an application (e.g., application 136) streaming video from a source device (e.g., host device 100) over a communications network (e.g., network 305) at a fixed frame rate in accordance with embodiments of the present invention. In one embodiment, host device 100 may be implemented as a server, laptop, desktop computer or the like, as contemplated by embodiments of the present invention. Also, in one embodiment, host device 100 may be implemented as a data center, remote server, or virtualized server. Additionally, embodiments of the present invention support host device 100 being implemented as a remote virtual host server that is communicably coupled to a plurality of remote client devices (e.g., client device 200) over a network (e.g., network 305) and operable to execute multiple instantiations of an application.

As illustrated by the embodiment depicted in FIG. 1A, frame memory buffer 215 may be configured to render frames associated with application 136 to display device 221. Frame memory buffer 215 may receive frames (e.g., video data 306) via receiver/decoder 210 at a fixed frame rate (e.g., 60 frames/second or “FPS”). Receiver/decoder 210 may decode video signals received with varying numbers of bits per frame (e.g., depending on the content of the frame being processed). As such, a varying number of decoded frames to be displayed may be placed within frame memory buffer 215 and queued for processing (e.g. via graphics processor 230) at different times. Frames may be removed from frame memory buffer 215 when displayed. Although one frame memory buffer is depicted in FIG. 1A, embodiments of the present invention may be operable to support configuration involving multiple buffers similar to frame memory buffer 215.

Buffer level monitoring module 211 may periodically monitor frame rates and/or a current number of frames queued within frame memory buffer 215 for rendering to display device 221. In one embodiment, buffer level monitoring module 211 may be configured to periodically monitor buffer-filled percentages. According to one embodiment, buffer level monitoring module 211 may be configured to detect instances of overflow and/or underflow within frame memory buffer 215 based on pre-determined minimum and/or maximum buffer level thresholds defined. Additionally, buffer level monitoring module 211 may maintain periodic communications with buffer throttling controller 208 which may enable buffer throttling controller 208 to dynamically gauge queue conditions within frame memory buffer 215.

In one embodiment, buffer level status signals 209 may provide data regarding frame rate data and/or a current number of pending frames set to be processed (e.g., via graphics processor 230) within frame memory buffer 215. When providing buffer level status signals 209 to buffer throttling controller 208, buffer level monitoring module 211 may take video decoding timings into account in a manner that does not require advanced video codec information. In one embodiment, buffer level monitoring module 211 may be configured to provide buffer level status signals 209 to buffer throttling controller 208 during fixed or varying time intervals (e.g., milliseconds).

Buffer throttling module 208 may be capable of updating or adjusting frame rates responsive to a current number of frames queued within frame memory buffer 215 and/or a fixed frame rate determined by a source device (e.g., host device 100). In one embodiment, buffer throttling module 208 may be capable of updating or adjusting frame rates responsive to a buffer-filled percentage. For instance, according to one embodiment, an acceptable frame queue size may be established using a pre-determined minimum buffer queue level threshold and a maximum buffer queue level threshold. As such, if a pre-determined buffer queue level threshold has been met or exceeded (e.g., maximum buffer queue level threshold or minimum buffer queue level threshold), buffer throttling controller 208 may send control signals (e.g., control signals 213) to graphics system 241, which may correspondingly adjust the display speed of frames to be rendered to display device 221. By adjusting the sink device's frame rate in this fashion, the sink device may approximate the source frame rate.

According to one embodiment, control signals sent by buffer throttling controller 208 may include instructions to update step size parameter values which may correspondingly increase or decrease display speeds (e.g., via increases or decreases in the frequency of display updates). The step size defines the amount the sink frame rate is adjusted by for an adjustment. In this manner, buffer throttling controller 208 may adjust the rate at which frames are rendered to display device 221 to approximate the rate at which video data 306 is streamed from host 100 and to client device 200.

In one embodiment, if the current number of frames detected within the buffer queue of frame memory buffer 215 meet or exceed a pre-determined buffer queue level threshold, buffer throttling controller 208 may correspondingly send control signals 213 to graphics system 241, which may increase or decrease the current rate at which frames are rendered to display device 221. In one embodiment, buffer throttling controller 208 may be configured to receive feedback from graphics system 241 via graphics system status signals regarding execution periods for rendering processes executed by the graphics system in response to frame requests received.

Additionally, according to one embodiment, buffer throttling module 208 may update or adjust frame rates responsive to queue level changes or trends detected within frame memory buffer 215 over a period of time. For instance, while frame queue levels within frame memory buffer 215 may be within acceptable threshold levels (e.g., within a pre-determined minimum and maximum buffer queue level threshold), empirical data gathered by buffer level monitoring module 211 over a period of time may indicate that the number of frames in the queue are approaching a pre-determined buffer queue level threshold (e.g., maximum buffer queue level threshold or minimum buffer queue level threshold).

For example, there may be increases in network speed, thus, allowing for a higher probability that a greater number of frames may be received and decoded by client device 200 and then placed within the queue of frame memory buffer 215 for rendering to display device 221. In one embodiment, if an increasing number of frames are detected within the buffer queue of frame memory buffer 215, buffer throttling controller 208 may correspondingly send control signals 213 to the graphics system 241 to increase the current rate at which frames are rendered to display device 221. Additionally, there may be decreases in network speed, thus, allowing for a higher probability that a lower number of frames may be received and decoded by client device 200 and then placed within the queue of frame memory buffer 215. In one embodiment, if a decreasing number of frames are detected within the buffer queue of frame memory buffer 215, buffer throttling controller 208 may send control signals 213 to the graphics system 241 to decrease the current rate at which frames are rendered to display device 221.

Furthermore, according to one embodiment, buffer throttling module 208 may update or adjust step size parameters responsive to oscillations detected between frame rates over a period of time. For instance, empirical data gathered by buffer level monitoring module 208 may provide data regarding various frame rate changes calculated over a period of time. As such, in one embodiment, buffer throttling controller 208 may perform additional calculations (e.g., summations) using these frame rate changes to determine whether there is oscillation around a particular value. For example, if calculated frame rate changes result in a zero summation, buffer throttling controller 208 may determine that graphics system 241 is oscillating around a particular value.

As such, in one embodiment, buffer throttling controller 208 may determine that the current step size is too large to reach a target frame rate (e.g., rate determined by host device 100) and, thus, may continuously update the current step size (e.g., update the step size to half of its current value) so that graphics system 241 may converge over time towards the target frame rate. Alternatively, if calculated frame rate changes result in a non-zero result, buffer throttling controller 208 may determine that the there is no oscillation. As such, buffer throttling controller 208 may determine that the current step size is suitable and, thus, may allow graphic system 241 to maintain its current step size value.

FIG. 1B is a graphical representation of frame buffer queue growth computations performed in accordance with embodiments of the present invention. A graphics system (e.g., graphics system 241) on a sink device may be configured to render frames associated with an application (e.g., application 136) to the display (e.g., display device 221) of the sink device (client device 200) at a pre-determined target frame rate (e.g., 60 FPS) as defined by a source device (e.g., host device 100). As such, step size values may be dynamically adjusted to approximate the target frame rate. For instance, as illustrated in FIG. 1B, function 400 may represent a set of sample points (e.g., sample points 401, 402, 403, 404, etc.) analyzed by buffer throttling controller 208 to compute queue growth within frame memory buffer 215 over a period of time responsive to frames received from the source device. As such, sample points 401, 402, 403 and 404 may represent a set of discrete frame queue sample points calculated by buffer level monitoring module 211 over a period of time. In one embodiment, data associated with sample points 401, 402, 403 and 404 may be included within the periodic buffer level status signals 209 periodically received by buffer throttling controller 208 from buffer level monitoring module 211. Buffer levels may be measured in frame numbers or buffer-filled percentages.

Additionally, as illustrated in FIG. 1B, a maximum buffer queue level threshold (e.g., maximum buffer queue level threshold 415) may be set to 100 frames and a minimum buffer queue level threshold (e.g., minimum buffer queue level threshold 410) may be set to 20 frames. As such, an acceptable frame queue size (e.g., target range) or band (e.g. band 454) for frame memory buffer 215 may be established between 100 frames and 20 frames. Based on the sample data presented FIG. 1B, buffer throttling controller 208 may determine negative and positive frame queue growth trends within frame memory buffer 215 at certain points during the time period evaluated.

For example, sample point 401 may represent a time period in which buffer level monitoring module 211 calculated that 45 frames are stored within the rendering queue of frame memory buffer 215. Also, sample point 402 may represent a time period in which buffer level monitoring module 211 calculated that the number of frames stored within the rendering queue of frame memory buffer 215 was 15 frames, which is also below the minimum buffer queue level threshold (e.g., minimum buffer queue level threshold 410). As such, within the time period between sample points 401 and 402, buffer throttling controller 208 may send control signals (e.g., control signals 213) to the graphics system 241 to decrease the rate at which frames are rendered to display device 221.

Additionally, sample point 403 may represent a time period in which the number of frames stored within the rendering queue of frame memory buffer 215 increased to 40 frames. As such, within the time period between sample points 402 and 403, buffer throttling controller 208 may send control signals (e.g., control signals 213) to the graphics system 241 to increase the rate at which frames are rendered to display device 221.

FIG. 1C is a graphical representation of exemplary oscillation detection analysis performed in accordance with embodiments of the present invention. According to one embodiment, buffer throttling controller 208 may detect oscillations by tracking the history of the last n (signed) values of frame rate changes associated with the video signal (e.g., video data 306) received from the source device (e.g., host device 100). In one embodiment, buffer throttling controller 208 may gather a set of frame rate data included within buffer level status signals 209 received from buffer level monitoring module 211 over a period of time. In one embodiment, buffer throttling controller 208 may be configured to gather and analyze a larger sample size of frame rate data, which may yield a better oscillation analysis.

Function 405 may represent a set of sample points (e.g., sample points 411, 412, 413, 414, etc.) gathered by buffer level monitoring module 208 and analyzed by buffer throttling controller 208 over a period of time. As such, sample points 411, 412, 413 and 414 may be computed instantaneous frame rates calculated by buffer level monitoring module 211 over a period of time (e.g., times 1 through 8). Accordingly, buffer throttling controller 208 may analyze sample points 411, 412, 413 and 414 and compute any changes in frame rates.

For instance, with reference to FIG. 1C, a graphics system (e.g., graphics system 241) may be configured to render frames associated with an application (e.g., application 136) to display device 221 at a pre-determined target frame rate (e.g., 60 FPS). As such, a step size rate may be configured (e.g. via graphic system 241) to correspond to the target frame rate. In one embodiment, buffer throttling controller 208 may perform a summation of the frame rate changes between sample points 411 (e.g., 59 FPS), 412 (e.g., 61 FPS), 413 (e.g., 59 FPS) and 414 (e.g., 61 FPS) and determine that while graphic system 241 changed display speeds several times over time, the average between sample points 411 and 412 (e.g., 60 FPS) and the average between sample points 413 and 414 (e.g., 60 FPS) remained the same.

In this manner, buffer throttling controller 208 may determine that there is oscillation around the frame rates and may correspondingly send control signals (e.g., control signals 213) to the graphics system 241 to update the step size value to one-half of its current value. As such, the adjustments to the step size may be repeated (e.g., continuously updating the current step size value to its half) so that graphics system 241 may be able to converge over time towards the pre-determined 60 FPS target frame rate.

### Exemplary Sink Device for Buffer Level Based Frame Rate Recovery

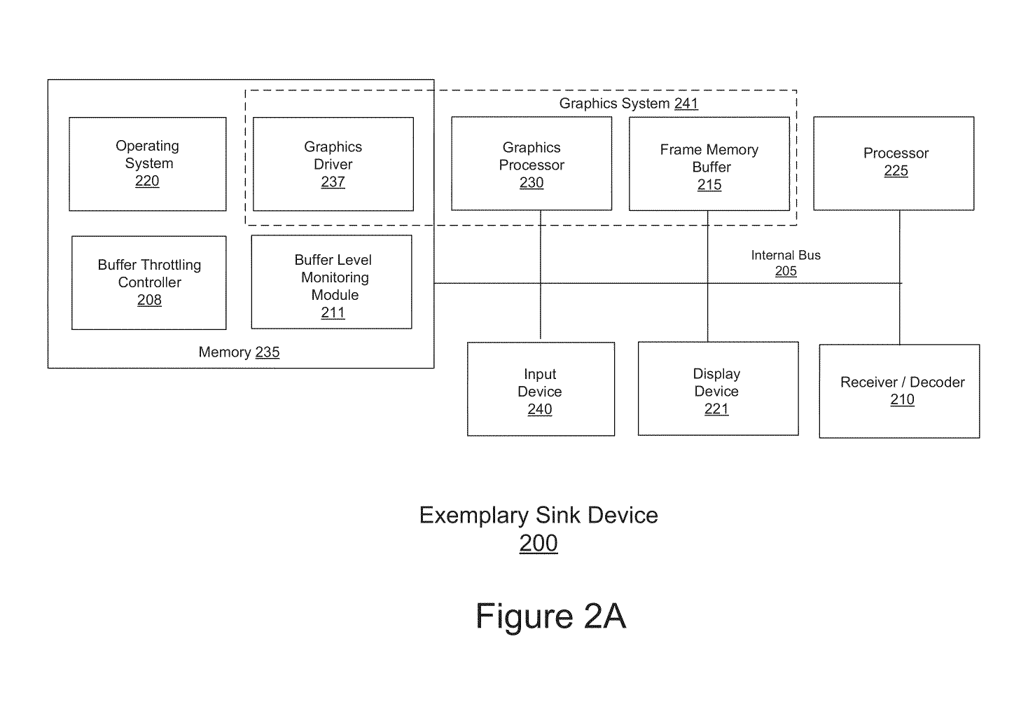

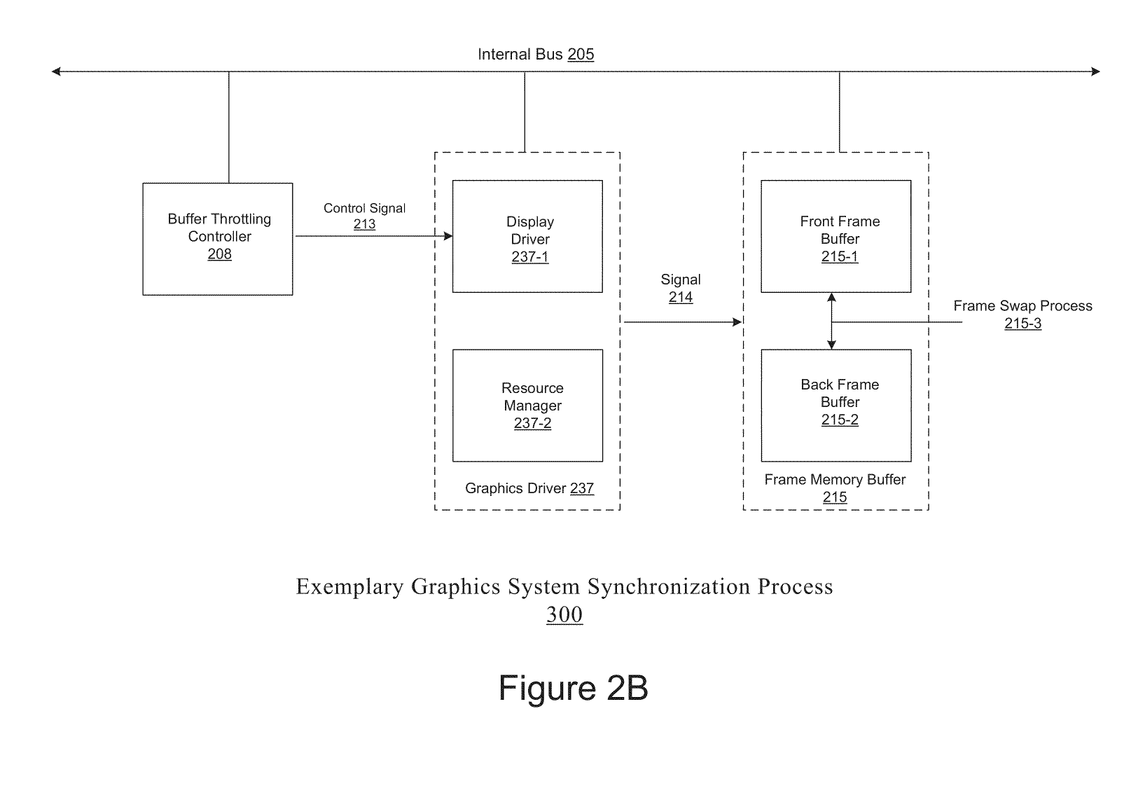

FIG. 2A provides an exemplary sink device (e.g., client device 200) upon which embodiments of the present invention may be implemented is depicted. Client device 200 may be implemented as a remote device which may communicate with other source devices or host computer systems (e.g., host device 100 of FIG. 1A). Furthermore, client device 200 may be any type of device that has display capability, the capability to decode (decompress) data (e.g., video signals), and the capability to receive inputs from a user and send such inputs to a host computer, such as host device 100.

Client device 200 includes processor 225 which processes instructions from an application (not pictured) located in memory 235 to read data received from receiver/decoder 210 and/or input device 240 and to store the data in frame memory buffer 215 for further processing via internal bus 205. Optionally, processor 225 may also execute instructions from operating system 220 also located in memory 235. Furthermore, input device 240 may include devices that communicate user inputs from one or more users to host device 100 and may include keyboards, mice, joysticks, touch screens, and/or microphones.

Receiver/Decoder 210 may include the functionality to enable client device 200 to communicate with other computer systems (e.g., host device 100 of FIG. 1A) via an electronic communications network, including wired and/or wireless communication and including the Internet. Furthermore, receiver/decoder 210 may include the functionality to decode (decompress) data that is encoded (compressed). In one embodiment of the present invention, receiver/decoder 210 may be an H.264 decoder.

Display device 220 may include the functionality to render visual information, including information received from receiver/decoder 230. Display device 220 may be configured to display visual information received from host device 100. Furthermore, display device 220 may be configured to detect user commands executed via touch screen technology or similar technology. The components of the client device 200 are connected via one or more internal bus 205.

In one embodiment, graphics system 241 may comprise graphics driver 237, graphics processor 230 and frame memory buffer 215. Graphics driver 237 may be used to configure graphics processor 230 and assist in generating a stream of rendered data to display devices (e.g., display device 221). In one embodiment of the present invention, graphics driver 237 may be comprised of a display driver (not pictured) and a resource manager (not pictured). Graphics processor 230 may include the functionality to generate pixel data for output images in response to rendering instructions by an application (e.g., application 136) and may be configured as multiple virtual graphic processors that are used in parallel (concurrently) by a number of applications executing in parallel.

Frame memory buffer 215 may include the functionality to store pixel data for each pixel of an output image. In another embodiment, frame memory buffer 215 and/or other memory may be part of memory 235 which may be shared with processor 225 and/or graphics processor 230. Additionally, in another embodiment, client device 200 may include additional physical graphics processors, each configured similarly to graphics processor 230. These additional graphics processors may be configured to operate in parallel with graphics processor 230 to simultaneously generate pixel data for different portions of an output image, or to simultaneously generate pixel data for different output images.

In one embodiment, buffer level monitoring module 211 may be implemented as a module residing within memory 235 that may be configured to periodically monitor frame rates and/or a current number of frames queued within frame memory buffer 215 for rendering to display device 221. In one embodiment, buffer monitoring module 211 may be implemented as a remote device communicably coupled to client device 200 and operable to provide feedback concerning frame rates and/or a current number of frames queued to buffer throttling controller 208 in accordance to embodiments of the present invention.

In one embodiment, buffer throttling controller 208 may be implemented as a module residing within memory 235 that includes the functionality to receive and send control signals to various components within client device 200. In one embodiment, buffer throttling controller 208 uses signals received from the buffer level monitoring module 211 to dynamically adjust the frame display rate of the sink device. In one embodiment, buffer throttling controller 208 may be implemented as an integrated circuit that is operable to receive and send control signals to various components within client device 200.

In one embodiment, buffer throttling controller 208 may be implemented to periodically receive signals in the form of status signals (e.g., buffer level status signals 209) from buffer level monitoring module 211 which enables buffer throttling controller 208 to frequently and dynamically gauge frame queue levels with frame memory buffer 215. In one embodiment, these signals may provide empirical data concerning frame rate data and/or a current number of pending frames set to be processed (e.g., via graphics processor 230) within frame memory buffer 215. Embodiments of the present invention support transmission of buffer level status signals to occur at either fixed or variable time intervals.

In one embodiment of the present invention, buffer throttling controller 208 may determine the amount of time receiver/decoder 230 spends decoding each frame as well as the time spent acquiring frames from a host computer system (e.g., host device 100). In one embodiment, buffer throttling controller 208 may be operable to periodically receive signals from graphics system 241 that provide empirical data regarding the amount of time graphics system 241 spends rendering frames to display device 221. Furthermore, embodiments of the present invention support transmission of these graphic status signals to occur at either fixed or variable time intervals.

FIG. 2B depicts an exemplary step size (e.g., frame rendering rate) adjustment process performed in accordance with embodiments of the present invention. As illustrated in FIG. 2B, buffer throttling controller 208 may determine that a pre-determined buffer queue level threshold has been met (e.g., minimum buffer queue level threshold or maximum buffer queue level threshold) and therefore sends control signals 213 to display driver 237-1. In response, display driver 237-1 may command frame memory buffer 215 via signal 214 (e.g., VBlank signal) to swap frames rendered in back frame buffer 215-2 to the front frame memory buffer 215-1.

Therefore, in one embodiment, when signal 214 is issued by display driver 237-1, frame memory buffer 215 may perform frame swap process 215-3 which swaps frames rendered in back frame buffer 215-2 to front frame memory buffer 215-1. At this point, graphics system 241 may now respond to requests made by an application (e.g., application 136) to begin rendering a new frame (e.g., rendering a frame in back frame buffer 215-2). In this manner, buffer throttling controller 208 may adjust the rate at which frames are rendered to display device 221 in proportion to the rate at which video data 306 is streamed from host 100 and to client device 200.

FIG. 3A presents a flowchart which describes exemplary operations in accordance with the various embodiments herein described to adjust the sink device frame rate.

At step 505, the host system streams frames of content associated with an application over a communications network at a target frame rate to a client device capable of receiving and decoding the frames.

At step 506, the buffer level monitoring module monitors a current number of frames queued and/or frame rate data within the frame memory buffer for rendering to a display device coupled to the client device.

At step 507, the buffer throttling controller receives periodic feedback via status signals sent from the buffer level monitoring module regarding the current number of frames queued within the frame memory buffer and/frame rate data.

At step 508, the buffer throttling module optionally receives feedback from the graphics system via graphics system status signals regarding execution periods for rendering processes executed by the graphics system in response to frame requests.

At step 509, a determination is made as to whether the current number of frames queued within the frame memory buffer meets or exceeds a pre-determined buffer queue level threshold (e.g. maximum or minimum threshold). If the threshold has not been met or exceeded according to the buffer throttling controller, then the buffer throttling controller withholds sending control signals to the graphics system and the graphics system continues to render frames at the current frame rendering rate (e.g., “display rate”), as detailed in step 510. If the threshold has been met or exceeded according to the buffer throttling controller, then the buffer throttling controller sends control signals to the graphics system to update the step size parameter value in a manner that increases or decreases the current frame rendering rate in proportion to the target frame rate, as detailed in step 511.

At step 510, the current number of frames queued within the frame memory buffer has not been met or exceeded according to the buffer throttling controller and, therefore, the buffer throttling controller withholds sending control signals to the graphics system and the graphics system continues to render frames at the current frame rendering rate. Additionally, the buffer level monitoring module continues to monitor conditions within the frame memory buffer, as detailed in step 506.

At step 511, the current number of frames queued within the frame memory buffer has been met or exceeded according to the buffer throttling controller and, therefore, the buffer throttling controller sends control signals to the graphics system to increase or decrease the current frame rendering rate in proportion to the target frame rate. Additionally, the buffer level monitoring module continues to monitor conditions within the frame memory buffer, as detailed in step 506.

FIG. 3B presents a flowchart which describes exemplary operations of how embodiments of the present invention may adjust display speeds responsive to queue level changes or trends detected within the frame memory buffer in accordance with embodiments of the present invention. The details of operation 511 (see FIG. 3A) are outlined in FIG. 3B.

At step 605, the buffer throttling controller analyzes data gathered from status signals received from the buffer level monitoring module over a period of time regarding frame queue levels within the frame memory buffer and/or frame rate data within the frame memory buffer.

At step 610, using the feedback received during step 605, the buffer throttling controller determines whether the current frame rate is oscillating between a particular value.

At step 615, the buffer throttling controller measures increases or decreases within the number of frames queued within the frame memory buffer.

At step 620, a determination is made as to whether the frames queued within the frame memory buffer are increasing towards a maximum pre-determined buffer queue level threshold. If the frames queued are increasing towards a maximum pre-determined buffer queue level threshold, then the buffer throttling controller sends control signals to the graphics system to increase the current frame rendering rate, as detailed in step 625. If the frames queued are not increasing towards a maximum pre-determined buffer queue level threshold, a determination is made as to whether the frames queued within the frame memory buffer are decreasing towards a minimum pre-determined buffer queue level threshold, as detailed in step 630.

At step 625, the frames queued are increasing towards a maximum pre-determined buffer queue level threshold and, therefore, the buffer throttling controller sends control signals to the graphics system to increase the current frame rendering rate.

At step 630, the frames queued are not increasing towards a maximum pre-determined buffer queue level threshold and, therefore, a determination is made as to whether the frames queued within the frame memory buffer are decreasing towards a minimum pre-determined buffer queue level threshold. If the frames queued are decreasing towards a minimum pre-determined buffer queue level threshold, then the buffer throttling controller sends control signals to the graphics system to decrease the current frame rendering rate, as detailed in step 635. If the frames queued are not decreasing towards a minimum pre-determined buffer queue level threshold, the buffer throttling controller does not send control signals to the graphics system and the graphics system maintains the current step size parameter value in a manner that maintains the current frame rendering rate, as detailed in step 640.

At step 635, the frames queued are decreasing towards a minimum pre-determined buffer queue level threshold and, therefore, the buffer throttling controller sends control signals to the graphics system to decrease the current frame rendering rate.

At step 640, the frames queued are not decreasing towards a minimum pre-determined buffer queue level threshold and, therefore, the buffer throttling controller does not send control signals to the graphics system and the graphics system maintains the current step size parameter value in a manner that maintains the current frame rendering rate.

FIG. 3C presents another flowchart which describes exemplary operations of how embodiments of the present invention may adjust step size parameter values responsive to queue level thresholds being met or exceeded in accordance with embodiments of the present invention. The details of operation 510 (see FIG. 3A) are outlined in FIG. 3C.

At step 705, the buffer throttling controller analyzes data gathered from status signals received from the buffer level monitoring module regarding the current number of frames queued and/or frame rate data within the frame memory buffer.

At step 710, using the feedback received during step 705, the buffer throttling controller determines whether the current frame rate is oscillating between a particular value.

At step 715, a determination is made as to whether the current number of frames queued within the frame memory buffer meet or exceed a pre-determined maximum buffer queue level threshold. If the frames queued meet or exceed a pre-determined maximum buffer queue level threshold, then the buffer throttling controller sends control signals to the graphics system to increase the current frame rendering rate, as detailed in step 720. If the frames queued do not meet or exceed a pre-determined maximum buffer queue level threshold, a determination is made as to whether the frames queued within the frame memory buffer meet or exceed a pre-determined minimum buffer queue level threshold, as detailed in step 725.

At step 720, the frames queued met or exceeded a pre-determined maximum buffer queue level threshold, therefore, the buffer throttling controller sends control signals to the graphics system to increase the current frame rendering rate.

At step 725, the frames queued did not meet or exceed a pre-determined maximum buffer queue level threshold and, therefore, a determination is made as to whether the frames queued within the frame memory buffer meet or exceed a pre-determined minimum buffer queue level threshold. If the frames queued meet or exceed a pre-determined minimum buffer queue level threshold, then the buffer throttling controller sends control signals to the graphics system to decrease the current frame rendering rate, as detailed in step 730. If the frames queued do not meet or exceed a minimum pre-determined buffer queue level threshold, the buffer throttling controller does not send control signals to the graphics system and the graphics system maintains the current step size parameter value in a manner that maintains the current frame rendering rate, as detailed in step 735.

At step 730, the frames queued met or exceeded a pre-determined minimum buffer queue level threshold and, therefore, the buffer throttling controller sends control signals to the graphics system to decreases the current frame rendering rate.

At step 735, the frames queued did not meet or exceed a pre-determined minimum buffer queue level threshold and, therefore, the buffer throttling controller does not send control signals to the graphics system and the graphics system maintains the current step size parameter value in a manner that maintains the current frame rendering rate.

FIG. 3D presents a flowchart which describes exemplary operations of how embodiments of the present invention may adjust frame rates responsive to frame rate oscillations in accordance with embodiments of the present invention. The details of operations 610 and 710 (see FIGS. 3B and 3D, respectively) are outlined in FIG. 3D.

At step 805, the buffer throttling controller analyzes data gathered from status signals received from the buffer level monitoring module over a period of time regarding frame rate changes detected within the frame memory buffer.

At step 810, using data gathered at step 805, the buffer throttling controller performs a summation on a set of frame rate changes detected over a period of time.

At step 815, the buffer throttling controller calculates an average value for the set of frame rate changes summed during step 810.

At step 820, a determination is made as to whether the average value calculated during step 815 was equal to zero. If the average equaled zero, then the buffer throttling controller determines that the frame rate is oscillating between a value and correspondingly sends control signals to the graphics system to continuously update the step size parameter value to half of its current value until the target frame rate is reached, as detailed in step 825. If the average does not equal zero, the buffer throttling controller determines that the frame rate is not oscillating between a value and does not send control signals to the graphics system, as detailed in step 830.

At step 825, the buffer throttling controller calculated an average value for the set of frame rate changes summed during step 810 to equal zero and, therefore, the buffer throttling controller determines that the frame rate is oscillating around a value and correspondingly sends control signals to the graphics system to update the step size parameter value to half of its current value until the target frame rate is reached. Additionally, the buffer throttling controller continues to monitor signals received from the buffer level monitoring module in the manner described in step 805.

At step 830, the buffer throttling controller calculated an average value for the set of frame rate changes summed during step 810 to equal a non-zero value and, therefore, the buffer throttling controller determines that the frame rate is not oscillating around a value and does not send control signals to the graphics system. As such, the graphics system maintains the current frame rendering rate. Additionally, the buffer throttling controller continues to monitor signals received from the buffer level monitoring module in the manner described in step 805.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method of adjusting a frame rate on a sink device, said method comprising:
receiving a plurality of frames from a source device over a communications network, wherein said plurality of frames are communicated to said sink device at a fixed frame rate;
storing frames to be displayed in a queue of a frame buffer;
monitoring a current number of frames stored within said queue on said sink device, wherein said sink device is operable to monitor said current number of frames in real-time; and
adjusting a frame display rate on said sink device responsive to said current number of frames stored within said queue to approximate said fixed frame rate.

2. The method as described in claim 1, wherein said monitoring further comprises monitoring a convergence of said current number of frames to a pre-determined buffer queue level threshold for said frame buffer and adjusting said frame display rate responsive to said convergence.

3. The method as described in claim 1, wherein said adjusting further comprises adjusting a current frame display rate responsive to increases or decreases in said current number of frames, wherein said current frame display rate is adjusted to a rate approximating said fixed frame rate.

4. The method as described in claim 1, wherein said adjusting further comprises detecting an oscillation in said frame display rate by performing a summation on a set of previous frame rate changes detected over a period of time.

5. The method as described in claim 4, wherein said detecting further comprises averaging said set of previous frame rate changes to determine said oscillation.

6. The method as described in claim 4, wherein said adjusting further comprises adjusting a current step size value responsive to said oscillation, wherein said current step size value is continuously adjusted to half of its current value until said frame display rate approximates said fixed frame rate.

7. The method as described in claim 1, wherein said monitoring step and said adjusting step are performed at fixed time intervals.

8. A system for adjusting a frame rate on a sink device, said system comprising:
a receiving module operable to receive a plurality of frames from a source device over a communications network, wherein said plurality of frames are communicated to said sink device at a fixed frame rate, wherein said receive module is operable to store frames to be displayed in a queue of a frame buffer;
a monitoring module operable to monitor a current number of frames stored within said queue on said sink device, wherein said monitoring module is operable to monitor said current number of frames in real-time; and
a controller operable to adjust a frame display rate on said sink device responsive to said current number of frames stored within said queue to approximate said fixed frame rate.

9. The system as described in claim 8, wherein said monitoring module is further operable to monitor a convergence of said current number of frames to a pre-determined buffer queue level threshold for said frame buffer and said controller is further operable to adjust said frame display rate responsive to said convergence.

10. The system as described in claim 8, wherein said controller is further operable to adjust a current frame display rate using a graphics system resident on said sink device responsive to increases or decreases in said current number of frames, wherein said current frame display rate is adjusted to a rate approximating said fixed frame rate.

11. The system as described in claim 8, wherein said controller is further operable to detect an oscillation in said frame display rate by performing a summation on a set of previous frame rate changes detected over a period of time.

12. The system as described in claim 11, wherein said controller is further operable to average said set of previous frame rate changes to determine said oscillation.

13. The system as described in claim 11, wherein said controller is further operable to adjust a current step size value using a graphics system resident on said sink device responsive to said oscillation, wherein said current step size value is continuously adjusted to half of its current value until said frame display rate approximates said fixed frame rate.

14. The system as described in claim 8, wherein said monitoring module is operable to monitor said current number of frames and said controller is operable to adjust said frame display rate on said sink device at fixed time intervals.

15. A method of adjusting a frame rate on a sink device, said method comprising:
receiving a plurality of frames from a source device over a communications network, wherein said plurality of frames are communicated to said sink device at a target frame rate;
storing frames to be displayed in a buffer queue;
monitoring a current number of frames stored within said buffer queue on said sink device, wherein said sink device is operable to monitor said current number of frames in real-time;
provided said current number of frames converges towards a pre-determined buffer queue threshold value, adjusting a frame display rate of said sink device; and
removing frames from said buffer queue for display at said frame rate of said sink device.

16. The method as described in claim 15, wherein said monitoring further comprises monitoring a convergence of said current number of frames towards a pre-determined maximum buffer queue level threshold and towards a pre-determined minimum buffer queue level threshold for said frame buffer.

17. The method as described in claim 15, wherein said adjusting further comprises adjusting a current frame display rate responsive to increases or decreases in said current number of frames, wherein said frame display rate is adjusted to a rate approximating said target frame rate.

18. The method as described in claim 15, wherein said adjusting further comprises detecting an oscillation in said frame display rate by performing a summation on a set of previous frame rate changes detected over a period of time.

19. The method as described in claim 18, wherein said detecting further comprises averaging said set of previous frame rate changes to determine said oscillation.

20. The method as described in claim 18, wherein said adjusting further comprises adjusting a current step size value responsive to said oscillation, wherein said current step size value is continuously adjusted to half of its current value until said frame display rate approximates said target frame rate.

21. The method as described in claim 15, wherein said monitoring step and said adjusting step are performed at varying time intervals.
